(19) United States
(12) Patent Application Publication
(10) Pub. No.: US 2017/0356809 A1
(43) Pub. Date: Dec. 14, 2017

(54) TEMPERATURE SENSOR

(71) Applicant: Valeo Systemes de Controle Moteur, Cergy Saint Christophe (FR)

(72) Inventors: Piotr Zakrzewski, Cergy Saint Christophe (FR); Mahmoud Sfaxi, Cergy Saint Christophe (FR); Nicolas Gelez, Cergy Saint Christophe (FR); Olivier Dixneuf, Cergy Saint Christophe (FR)

(73) Assignee: Valeo Systemes de Controle Moteur, Cergy Saint Christophe (FR)

(21) Appl. No.: 15/528,276

(22) PCT Filed: Nov. 20, 2015
(86) PCT No.: PCT/FR2015/053151

§ 371 Date: Aug. 11, 2017

(30) Foreign Application Priority Data
Nov. 21, 2014 (FR) 1461306

(51) Int. Cl. G01K 7/02; G01K 1/08; G01K 13/02; G01K 1/20; G01K 1/12

(52) U.S. Cl. CPC G01K 7/02; G01K 1/20; G01K 1/12; G01K 13/02; G01K 1/08; G01K 2205/04; G01K 2205/02

(57) ABSTRACT

The invention relates to a temperature sensor comprising a thermocouple (7) defining a hot point (13), said temperature sensor comprising a mineral insulated cable (14) with an outer diameter greater than 2 mm and less than 5 mm and a reinforcement tube (60) from which projects the mineral insulated cable at the hot point end, so as to form a swaging.

### TECHNICAL FIELD

This invention relates to a temperature sensor comprising a thermocouple designed to measure temperatures that can vary between −40° C. and +1200° C. particularly in a heat engine of a motor vehicle.

### PRIOR ART

As shown in FIG. 1, a temperature-measuring device conventionally comprises a temperature sensor 2 extended by an extension cable 3 allowing the temperature sensor to be connected to a measuring device 4. The temperature sensor 2 conventionally comprises a metal protective sleeve 5 and a stop 6, mounted on the protective sleeve 5 and adapted according to the application envisaged.

The measuring device 4 is designed to interpret the electrical signal provided by the temperature sensor 2 and transmitted through the extension cable 3. This interpretation enables an assessment of the temperature to which the end of the temperature sensor is subjected.

Inside the protective sleeve 5, the temperature sensor 2 conventionally comprises a thermocouple 7 and a mineral insulation 8, conventionally aluminum or magnesium, which allows the thermocouple to withstand environmental stress and, in particular, high temperatures.

As shown in FIG. 2, the thermocouple 7 is an assembly of first and second conductor wires, 10 and 12, respectively, connected to each other and tip-to-tip in a hot point 13. The difference in potential AU at the terminals of the first and second conductor wires depends on the difference between the temperature at the hot point T₁ and the temperature T₀ at said terminals, according to the well-known Seebeck effect.

The conventional method of manufacturing a temperature sensor designed for applications in which the temperature can vary between −40° C. and 1200° C., involves the following steps:

Firstly, a mineral insulated cable (MIC) 14 is made.

A mineral insulated cable comprises a metal protective sleeve 5 and, inside the protective sleeve 5, two thermocouple wires 10 and 12 of suitable materials to form a thermocouple, the two thermocouple wires being isolated from one another and from the protective sleeve 5 by means of mineral insulation 8 (FIG. 3a).

In order to form the connection between the two thermocouple wires, or “hot point” 13, some of the insulation material is extracted from one of the cable ends, for example by sanding or scraping, typically to a depth of between 2 and 10 mm. At this so-called “distal” end, the two thermocouple wires thus emerge from the insulation, while being encircled by the protective sleeve 5 (FIG. 3b).

The two terminal parts of the thermocouple wires thus released are mechanically brought together until they are in contact with each other, then connected, for example by electric welding (FIG. 3c).

The emptied terminal part of the protective sleeve can then, optionally, be filled with insulating material, identical or different from the mineral insulation of the mineral insulated cable, then closed again, for example by electric welding, so as to protect the thermocouple (FIG. 3d).

Furthermore, after closing the protective sleeve 5 or before cutting the mineral insulated cable, conventionally a swaging 15 is made on the distal terminal part of the protective sleeve 5, conventionally by drawing or hammering. The swaging conventionally improves the response time of the temperature sensor. Such a manufacturing method is difficult to automate, however, and currently involves delicate manual operations.

A need therefore exists for a solution that facilitates the automation of the manufacture of a temperature sensor with a thermocouple.

One aim of the invention is to meet this need.

### SUMMARY OF THE INVENTION

This invention proposes a method for the manufacture of a temperature sensor with a thermocouple comprising the following successive steps:
a) manufacture of a mineral insulated cable comprising two thermocouple wires extending along the entire length of the cable and embedded in a mineral insulation, the mineral insulation being encircled by a protective sleeve, the outer diameter of the mineral insulated cable being greater than 2 mm and less than 5 mm, preferably less than 4mm;
b) extraction of mineral insulation from one of the ends of the mineral insulated cable to a depth of between 2 and 7 mm so as to release the terminal parts of the thermocouple wires;
c) connection of the terminal parts of the thermocouple wires thus released, so as to form a thermocouple hot point;
d) protection of said hot point by encapsulation by means of the protective sleeve;
e) independently of the preceding steps, preferably after step d), protection of the protective sleeve by means of a reinforcement tube, the reinforcement tube allowing said protective sleeve to pass beyond said protection sleeve at said hot point end (distal end).

As will be seen in further detail in the rest of the description, the combination of a small-diameter mineral insulated cable and a reinforcement sleeve receiving the mineral insulated cable allows a swaging to be formed and thus limit, or even do away with the swaging conventionally formed by deformation of the protective sleeve. Automation of the manufacturing method is considerably simplified.

Moreover, this results in an improvement in the mechanical resistance of the temperature sensor and thus lengthens its life.

A method according to the invention can therefore comprise one or more of the following optional features:
on completing step d), the protective sleeve has a constant diameter along more than 80%, more than 90%, more than 95%, even substantially 100% of its length;
the reinforcement tube is fixed by welding to the protective sleeve;
during the encapsulation in step d), an insulation material is encapsulated, preferably in the form of powder, identical or different to the mineral insulation of the mineral insulated cable, preferably made of a material chosen from aluminum and/or magnesium, so that after step d), said terminal parts of the encapsulated thermocouple wires are insulated from the outside by said insulation material.

The invention also proposes a temperature sensor comprising a thermocouple defining a hot point, said temperature sensor comprising a mineral insulated cable with an outer diameter of less than 4mm and a reinforcement tube partially housing the mineral insulated cable, the mineral insulated cable projecting beyond the reinforcement tube at the hot point end, so as to form a swaging.

A temperature sensor according to the invention can in particular be manufactured by adopting a method according to the invention, possibly adapted so that the temperature sensor has one or more of the optional features described below.

A temperature sensor according to the invention may also comprise one or more of the following optional features:
the length of the part of the mineral insulated cable that projects beyond the reinforcement tube, at the hot point end, is greater than 5 mm, preferably greater than 7 mm, preferably greater than 9 mm and/or less than 15 mm, preferably less than 13 mm, preferably less than 11 mm;
the mineral insulated cable projects beyond the distal end of the reinforcement tube, i.e. at the hot point end, so that, depending on the direction of the length of mineral insulated cable, the hot point is located beyond the distal end of the reinforcement tube;
the outer diameter of the mineral insulated cable is preferably less than 3.5 mm, preferably less than 3 mm, preferably less than 2.5 mm, preferably less than 2 mm, preferably less than 1.5 mm, preferably less than 1.2 mm;
preferably, the protective sleeve has no swaging or comprises a swaging with an outer diameter greater than the inner diameter of the protective sleeve beyond the region of said swaging or has a swaging with an outer diameter greater than 80%, preferably greater than 90%, preferably greater than 95% of the outer diameter of the protective sleeve beyond the region of said swaging;
the reinforcement tube covers more than 10%, more than 30%, more than 60%, more than 90%, preferably substantially 100% of the outer lateral surface of the protective sleeve of the mineral insulated cable;
the wall of the reinforcement tube has a thickness greater than or equal to 0.3 mm and/or less than 1.2 mm;
the combined thickness of the protective sleeve and the reinforcement tube is greater than 16% and/or less than 70% of the outer diameter of the mineral insulated cable;
the reinforcement tube is fixed to the protective sleeve, preferably by laser welding, preferably at the distal end of the reinforcement tube;
the temperature sensor comprises a fixed mechanical stop, preferably welded, on the reinforcement tube.

The invention also concerns the use of a temperature sensor according to the invention in an environment at a temperature of above 800° C., 900° C., 1000° C., 1100° C. and/or below −10° C., −20° C., −30° C., preferably varying between −40° C. and 1200° C., and in particular in a heat engine of a motor vehicle.

Lastly, the invention relates to a heat engine of a motor vehicle comprising a temperature sensor according to the invention, and a motor vehicle comprising a heat engine according to the invention. The temperature sensor can in particular be arranged in the exhaust manifold upstream of a turbine of a turbocharger or in a fuel or combustion intake pipe or in an exhaust pipe.

### BRIEF DESCRIPTION OF THE FIGURES

Further features and advantages of the invention will emerge from the following detailed description and an examination of the accompanying drawings, in which:

FIG. 1 is a schematic representation of a temperature sensor connected to a measuring device;

FIG. 2 is a schematic illustration of the principle of operation of a thermocouple;

FIG. 3 (FIGS. 3a to 3d) shows the method of manufacture of a temperature sensor according to the prior art; and

FIG. 4 is a longitudinal section of a temperature sensor according to the invention.

### DEFINITIONS

“Proximal” and “distal” distinguish the two ends of a temperature sensor according to the invention. The “distal” end is that of the hot point.

“Hot point” conventionally describes the connection between the two thermocouple wires, regardless of its temperature.

The mineral insulated cable has a smaller outer diameter than that of the reinforcement tube. This is why the part of the mineral insulated cable that extends beyond the reinforcement tube, at the hot point end, is called a “swaging”.

An “insulating material” or “mineral insulation” means, unless stated otherwise, any material having an electrical resistance greater than 10 MV/m and resistivity at room temperature greater than 1 GΩm, typically made of ceramic materials;

“Comprising a”, “having a” or “including a”, means “comprising at least one”, unless stated otherwise.

Identical reference numerals are used to identify the same parts in the different Figures.

### DETAILED DESCRIPTION

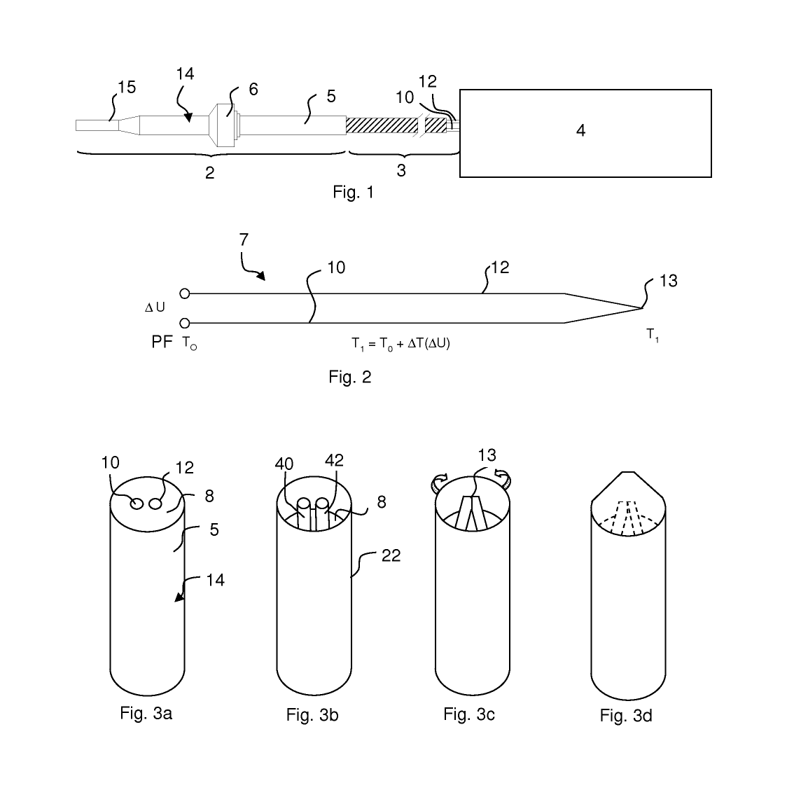

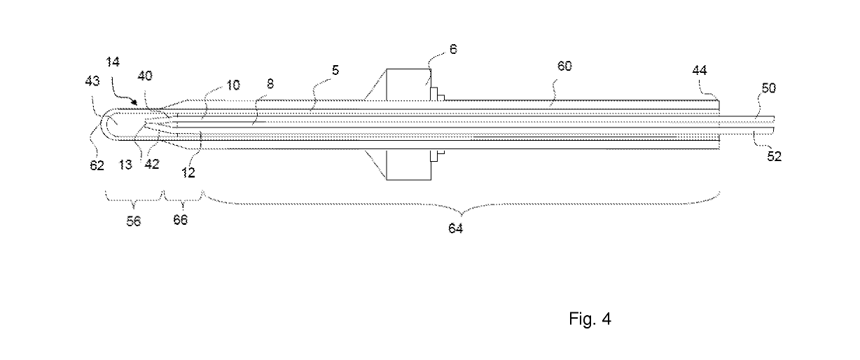

As FIGS. 1 to 3 have been described in the preamble, reference will now be made to FIG. 4.

A thermocouple sensor according to the invention is manufactured from a small-diameter mineral insulated cable 14.

The protective sleeve 5 can be made of any electrically conductive material, preferably of a material chosen from stainless steels, preferably of the Inconel family with a wall typically of a thickness of around 10% of the outer diameter of the mineral insulated cable, preferably of a thickness exceeding 10% in order to promote mechanical strength. The thermocouple wires 10 and 12 can be flexible or rigid. Preferably, they have a substantially circular cross section.

Preferably the pair of materials of the first and second thermocouple wires 10 and 12 is NiSil/NiCroSil.

The projecting distal terminal parts 40 and 42 of the thermocouple wires 10 and 12 that extend beyond the mineral insulation 8 conventionally connect together at the hot point 13. They are housed in a chamber 43 resulting from encapsulation, preferably filled with an insulating material, preferably of a mineral nature, that can be identical or different to that contained in the protective sleeve of the mineral insulated cable. Preferably, the insulating material is a material chosen from the group formed by aluminum and/or magnesium.

The projecting proximal terminal parts 50 and 52 of the thermocouple wires 10 and 12 that may extend beyond the proximal end 44 of the mineral insulated cable 14 can have a length greater than 5 cm, greater than 10 cm, greater than 20 cm, greater than 50 cm. Advantageously, these wires can thus serve as an extension cable 3 so as to electrically connect the temperature sensor 2 to the measuring device 4. Clearly, if the thermocouple wires are used as an extension cable, their projecting proximal end parts 50 and 52 must be electrically insulated.

At their proximal end, the thermocouple wires 10 and 12 comprise electrical connection means, for example connection terminals enabling their connection to the measuring device 4 and/or to an extension cable 3.

In an embodiment shown in FIG. 4, the protective sleeve 5 of the mineral insulated cable has no swaging. Its diameter is substantially constant from its proximal end 44 to its distal end 62. As a variation, the protective sleeve 5 of the mineral insulated cable has a reduced swaging, preferably a swaging with an outer diameter greater than the inner diameter of the protective sleeve 5 beyond the region of said swaging.

The temperature sensor comprises a reinforcement tube 60, preferably made of Inconel, partially covering the protective sleeve.

In an embodiment, the reinforcement tube 60 is fixed to the protective sleeve preferably by welding.

Preferably, the outer diameter of the reinforcement tube 60 is less than 7 mm, than 6 mm, than 5 mm, than 4 mm, than 3 mm.

The inner lateral surface of the reinforcement tube, which delimits the bore of the reinforcement tube, rests on the outer lateral surface 22 of the protective sleeve 5. Preferably, the bore of the reinforcement tube is of a shape that is substantially complementary to the outer lateral surface 22 of the protective sleeve 5, which allows close contact between the inner lateral surface of the reinforcement tube and the outer lateral surface 22 of the protective sleeve 5. Preferably, the reinforcement tube extends to the proximal end 44 of the protective sleeve. However, the reinforcement tube does not extend to the distal end 62 of the protective sleeve. Preferably, the reinforcement tube comprises a tapered distal terminal part so that its outer diameter gradually joins the outer diameter of the protective sleeve.

More preferably, a mechanical stop 6 is fixed, preferably welded, to the reinforcement tube 60. The mechanical stop 6 advantageously enables a precise local adaptation of the diameter of the temperature sensor, and thus good compatibility with the application envisaged. Preferably, the largest transverse dimension of the mechanical stop (i.e. in a plane perpendicular to the longitudinal direction corresponding to the length of the mineral insulated cable) is greater than 8 mm and/or less than 25 mm.

Travelling along the temperature sensor from the mechanical stop 6, or even from the proximal end 44 (passing over the mechanical stop 6), up to the distal end 62, the outer lateral surface of the temperature sensor thus comprises a cylindrical portion 64 the outer diameter of which is defined by the reinforcement tube 60, an intermediate portion 66, corresponding to the tapered distal terminal part of the reinforcement tube, and a swaging 56. Advantageously, the swaging 56 improves the response time of the temperature sensor. In order to have a sufficient response time, the outer diameter of the swaging at the hot point is preferably less than 3.5 mm, or less than 3 mm, or less than 2 mm, or less than 1.5 mm.

The length of the swaging 56 is preferably greater than 5 mm and/or less than 15 mm.

A temperature sensor according to the invention can be manufactured by following the above steps a) to e).

Steps a) to c) can correspond to the steps conventionally implemented according to the prior art, as described in the preamble.

At step a), a mineral insulated cable or section of mineral insulated cable is prepared.

At step b), the mineral insulation material can be extracted from one of the ends of the mineral insulated cable, as in the prior art, preferably to a depth of between 2 and 7 mm, so as to release the distal end parts of the thermocouple wires.

At step c), as shown in FIG. 4, the distal terminal parts 40 and 42 of the thermocouple wires 10 and 12 are connected to each other, i.e. placed in physical contact and electrically connected, in a final manner, so as to form a hot point 13. The connection is preferably achieved by hot welding.

At step d), the thermocouple resulting from the connection of the two thermocouple wires is encapsulated so as to be protected from the environment.

In a preferred embodiment, the hot point 13 is encapsulated by deformation of the protective sleeve, then by welding, as according to the prior art illustrated by the arrows in FIG. 3c.

Preferably, the encapsulation in the protective sleeve is performed without forming a swaging from said protective sleeve. The outer diameter of the mineral insulated cable is therefore substantially constant up to its distal end 62.

Preferably, the chamber 43 resulting from the encapsulation is filled with an insulating material, identical or different to the mineral insulation of the mineral insulated cable, preferably of powder. The insulation material powder can, in particular, be aluminum powder or magnesium powder.

At step e), the mineral insulated cable is introduced, preferably by force, into the longitudinal bore of the reinforcement tube to a position in which its distal terminal part extends beyond the distal end of the reinforcement tube. This distal terminal part thus defines the swaging 56.

Preferably, the reinforcement tube is fixed, preferably welded to the protective sleeve 5.

As is now clear, the steps of a manufacturing method according to the invention, and particularly obtaining a swaging, are simple and can be automated. This results in a significant reduction in manufacturing costs. Obviously, the invention is not limited to the embodiment described and represented, provided for illustration purposes only.

1. A temperature sensor comprising:
a thermocouple defining a hot point;
a mineral insulated cable with an outer diameter greater than 2 mm and less than 5 mm; and
a reinforcement tube from which projects the mineral insulated cable at the hot point end, so as to form a swaging.

2. The temperature sensor according to claim 1, wherein the outer diameter of the mineral insulated cable is less than 3.5 mm.

3. The temperature sensor according to claim 1, wherein the reinforcement tube covers more than 90% of the outer lateral surface of the protective sleeve of the mineral insulated cable.

4. The temperature sensor according to claim 1, wherein the reinforcement tube comprises a lateral wall with a thickness greater than or equal to 0.3 mm.

5. The temperature sensor according to claim 1, wherein the length of the part of the mineral insulated cable that projects beyond the reinforcement tube, at the hot point end, is greater that 5 mm.

6. The temperature sensor according to claim 1, wherein the protective sleeve has no swaging or comprises a swaging with an outer diameter greater than the inner diameter of the protective sleeve beyond the region of said swaging.

7. The temperature sensor according to claim 1, comprising a mechanical stop fixed on the reinforcement tube.

8. A method for the manufacture of a temperature sensor with a thermocouple according to claim 1, said method comprising the following, executed successively:
manufacturing a mineral insulated cable comprising two thermocouple wires extending along the entire length of the cable and embedded in a mineral insulation, the mineral insulation being encircled by a protective sleeve, the outer diameter of the mineral insulated cable being less than 4 mm;
extracting mineral insulation from one of the ends of the mineral insulated cable to a depth of between 2 and 7 mm so as to release the terminal parts of the thermocouple wires;
connecting the terminal parts of the thermocouple wires thus released, to form a thermocouple hot point;
protecting said hot point by encapsulation by the protective sleeve; and
independently of the preceding steps, and after protecting the hot point by encapsulation, after protecting of the protective sleeve by a reinforcement tube, the reinforcement tube allowing said protective sleeve to pass beyond said protection sleeve at said hot point end.

9. The temperature sensor according to claim 1, wherein the sensor is use in an environment at a temperature of above 100° C.

10. A heat engine of a motor vehicle comprising a temperature sensor according to claim 1.
